(19) United States
(12) Patent Application Publication
(10) Pub. No.: US 2008/0071609 A1
(43) Pub. Date: Mar. 20, 2008

(54) Skill evaluating method, skill evaluating apparatus, and computer product

(75) Inventors: Takashi Yanase, Kawasaki (JP); Isao Namba, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki-shi (JP)

(21) Appl. No.: 11/657,637

(22) Filed: Jan. 25, 2007

(30) Foreign Application Priority Data
Sep. 14, 2006 (JP) 2006-249831

(51) Int. Cl. G06Q 10/00; G06F 19/00

(52) U.S. Cl. 705/11; 705/1; 705/7; 702/182; 702/1; 702/127

(57) ABSTRACT

A basic work time corresponding to a work item received as case information is extracted from a basic work-time database. A standard work time generally required to process a case is computed. The standard work time is compared with an actual work time to evaluate work skill of each operator.

### BACKGROUND OF THE INVENTION

1. Field of the Invention

The present invention relates to a technology for evaluating skill of a customer support operator.

2. Description of the Related Art

In large support centers where operators handle telephone inquiries and perform maintenance works, technologies have been disclosed to grasp work skill for evaluating quickness and accuracy of each operator's processing the work, intending to effectively educate the operators. For example, Japanese Patent Laid-Open No. 2001-166681 discloses a technology for evaluating skill of an operator by specifying a single work process with respect to each piece of trouble information in advance, retaining a standard work time generally required for an operator to complete the work process, and comparing the standard work time with an actual work time that the target operator actually spent to complete the work.

However, in the conventional technology, contents, propriety, and originality of the work process is not taken into account when the work skill is evaluated.

For example, during maintenance work in the support center, although a plurality of work processes can be performed to fix a trouble with a computer device, the single work process is selected for each trouble category in advance. The standard work time for the selected work process is retained, and is compared with the actual work time to evaluate the work skill. In such an evaluation, the work items and the propriety of the works are not taken into account when the work skill of each operator is evaluated.

Moreover, while work skill of an operator who completed the maintenance work in a short time by performing a unique work process should be highly evaluated, the uniqueness of the work process is not taken into account with such a technology that compares the actual work time with the single standard work time of the predetermined work process.

### SUMMARY OF THE INVENTION

It is an object of the present invention to at least partially solve the problems in the conventional technology.

According to an aspect of the present invention, a skill evaluating apparatus that evaluates skill of an operator, includes a storing unit that stores therein in advance a basic work time required for the operator to perform each work item in a work process for processing a case, an information receiving unit that receives information on at least a work item and an actual work time taken to process a case from the operator, a basic-work-time extracting unit that extracts, from the storing unit, a basic work time that corresponds to the work item informed by the operator, a standard-work-time computing unit that computes a standard work time generally required to process the case based on extracted basic work time, and an evaluating unit that evaluates skill of the operator by comparing the actual work time with the standard work time.

According to another aspect of the present invention, a skill evaluating method for evaluating skill of an operator includes storing in advance a basic work time required for the operator to perform each work item in a work process for processing a case, receiving information on at least a work item and an actual work time taken to process a case from the operator, extracting a basic work time that corresponds to the work item informed by the operator, computing a standard work time generally required to process the case based on extracted basic work time, and evaluating skill of the operator by comparing the actual work time with the standard work time.

According to still another aspect of the present invention, a computer-readable recording medium stores therein a computer program that causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of a skill evaluating apparatus according to a first embodiment of the present invention;

FIG. 2 is a block diagram of the skill evaluating apparatus;

FIG. 3 is an example of an input screen displayed on an operator terminal shown in FIG. 2;

FIG. 4 is an example of contents of a case database shown in FIG. 2;

FIG. 5 is an example of contents of a basic work-time database shown in FIG. 2;

FIG. 6 is an example of contents of a work skill database shown in FIG. 2;

FIG. 7 is a chart of equations to calculate case skill and work skill values according to the first embodiment;

FIG. 8 is a flowchart of the operation of a case-information receiving unit shown in FIG. 2;

FIG. 9 is a flowchart of the operation of a standard-work-time computing unit shown in FIG. 2;

FIG. 10 is a flowchart of the operation of a work-skill computing/notifying unit shown in FIG. 2;

FIG. 11 is a block diagram of a skill evaluating apparatus according to a second embodiment of the present invention;

FIG. 12 is an example of contents of a case database shown in FIG. 11;

FIG. 13 is an example of contents of a work-probability-distribution database shown in FIG. 11;

FIG. 14 is a flowchart of the operation of a proper-work determining unit shown in FIG. 11;

FIG. 15 is a flowchart of the operation of a work-probability-distribution computing unit shown in FIG. 11;

FIG. 16 is a flowchart of the operation of a standard-work-time computing unit shown in FIG. 11;

FIG. 17 is detailed flowchart of a standard-work-time computing process for a proper work item shown in FIG. 16;

FIG. 18 is an example of computing a standard work time of a proper work item according to the second embodiment;

FIG. 19 is a schematic of a computer that executes a skill evaluating program; and

FIG. 20 is a schematic of another computer that executes the skill evaluating program.

### DETAILED DESCRIPTION OF THE PREFERRED EMBODIMENTS

Exemplary embodiments of the present invention are explained below in detail referring to the accompanying drawings. The present invention is not limited to the embodiments explained below.

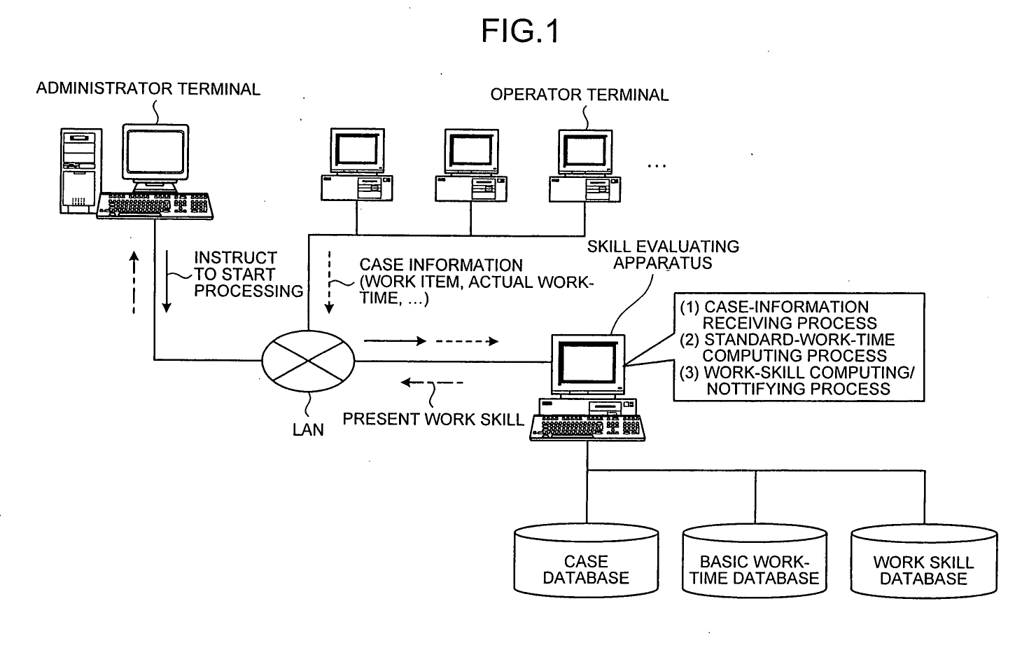

FIG. 1 is a schematic of a skill evaluating apparatus 30 according to a first embodiment of the present invention.

The skill evaluating apparatus evaluates skill of an operator who handles customer support and takes into account a work item that represents content of a work process that the operator can perform.

In other words, the skill evaluating apparatus is communicably connected to an administrator terminal used by an administrator of a support center and an operator terminal used by an operator engaged in customer support in the support center via a network such as a local area network (LAN).

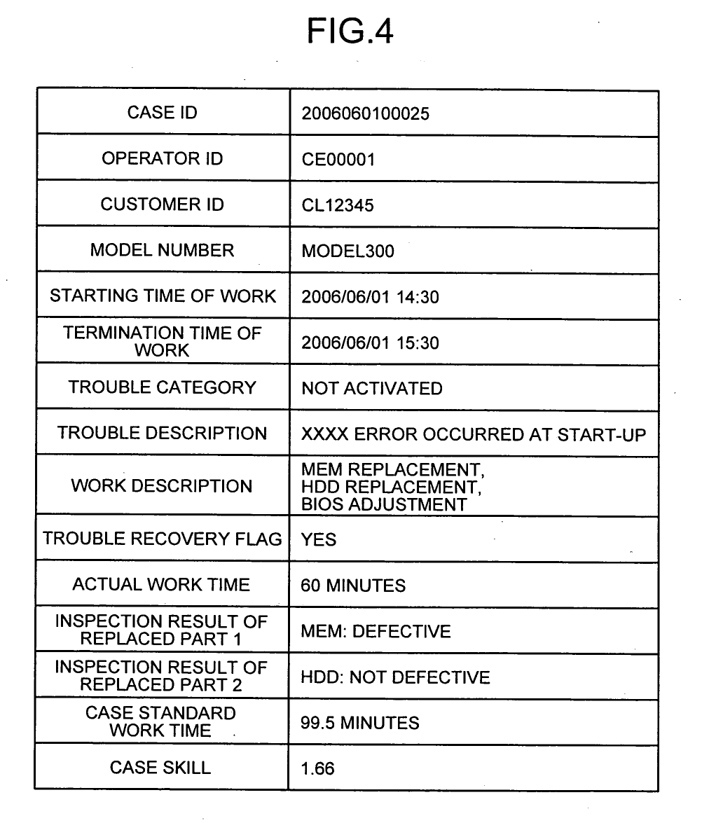

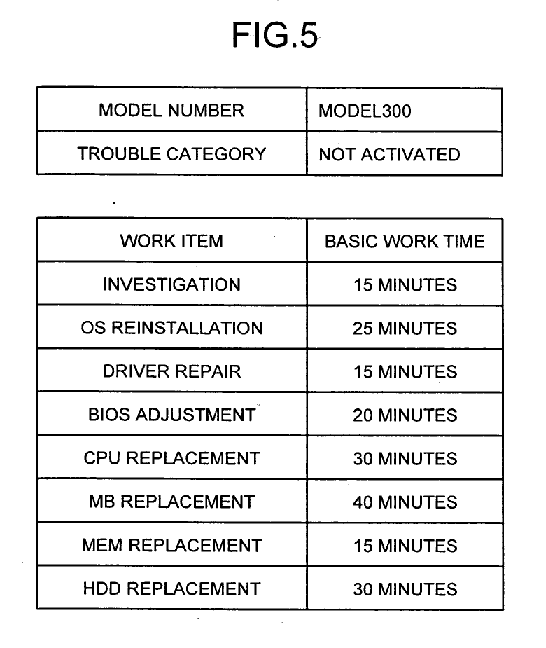

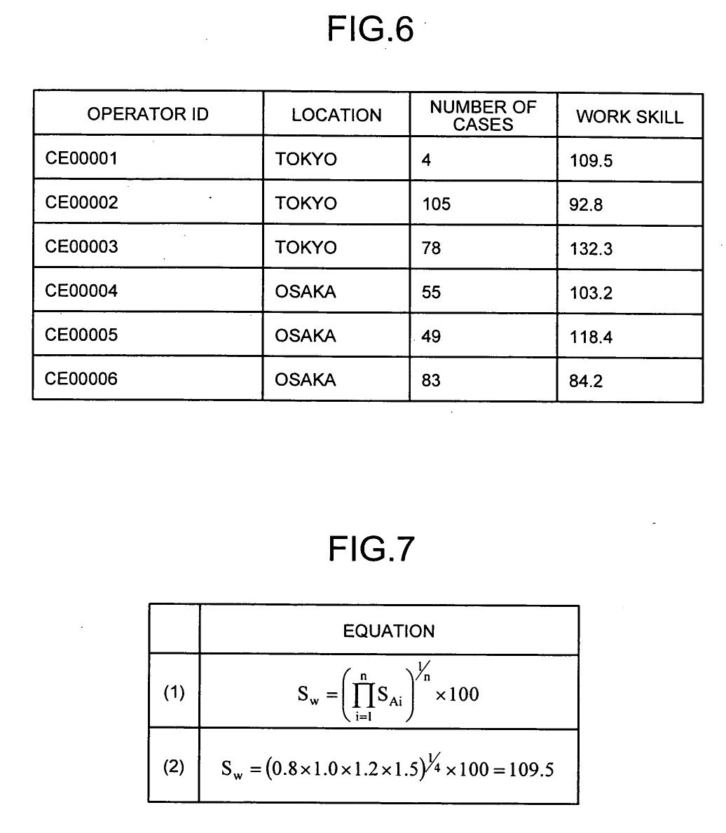

The skill evaluating apparatus includes a case database (see FIG. 4) that stores therein case information including, for example, a work item and an actual work time upon receiving the case information from the operator terminal. The skill evaluating apparatus also includes a basic work-time database (see FIG. 5) that stores therein a basic work time that an operator basically takes to perform a specific work item with respect to each work item that represents content of the work process. The skill evaluating apparatus further includes a work skill database (see FIG. 6) that stores therein work skill value computed with respect to each operator upon receiving an instruction from the administrator terminal to start processing.

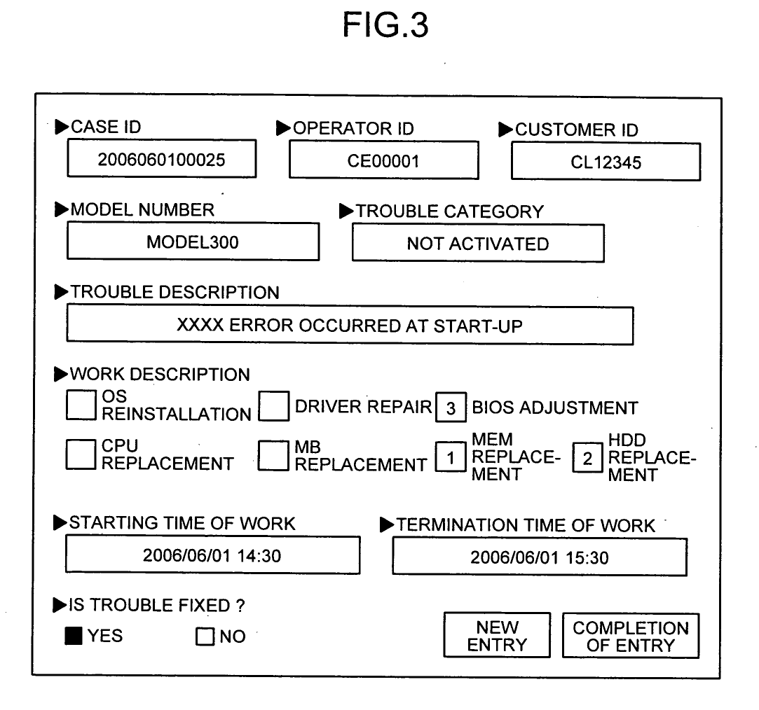

The skill evaluating apparatus sequentially receives case information (see (1) in FIG. 1). In other words, when the skill evaluating apparatus receives a request for an input screen (see FIG. 3) from a terminal of an operator that is going to process a new case, the skill evaluating apparatus writes and stores the information input through the input screen in the case database.

Furthermore, for example, when the skill evaluating apparatus receives an instruction to start processing from the administrator terminal, the skill evaluating apparatus computes a standard work time (see (2) in FIG. 1). In other words, the skill evaluating apparatus extracts the basic work time corresponding to the work item received as the case information from the basic work-time database, i.e., extracts a plurality of the basic work times if there is a plurality of the work items. The standard work time indicative of standard time required to process the case is computed based on the extracted basic work time, for example, by adding up the extracted basic work times.

Furthermore, for example, when the skill evaluating apparatus receives the instruction to start processing from the administrator terminal, the skill evaluating apparatus computes and indicates a work skill value (see (3) in FIG. 1). In other words, to compare the actual work time received as the case information with the computed standard work time, the skill evaluating apparatus computes a case skill value for all cases processed by the operator. The case skill value is calculated by dividing the standard work time by the actual work time. If the operator processes the case in a time shorter than the standard work time, the case skill value is more than one. By calculating a geometric mean of the case skill values, work skill of the operator is acquired. If the actual work time is shorter than the standard work time, the skill of the operator is high. The skill evaluating apparatus then notifies the administrator terminal of the work skill.

In this manner, according to the first embodiment, the work items are taken into account when the skill of the operator is evaluated.

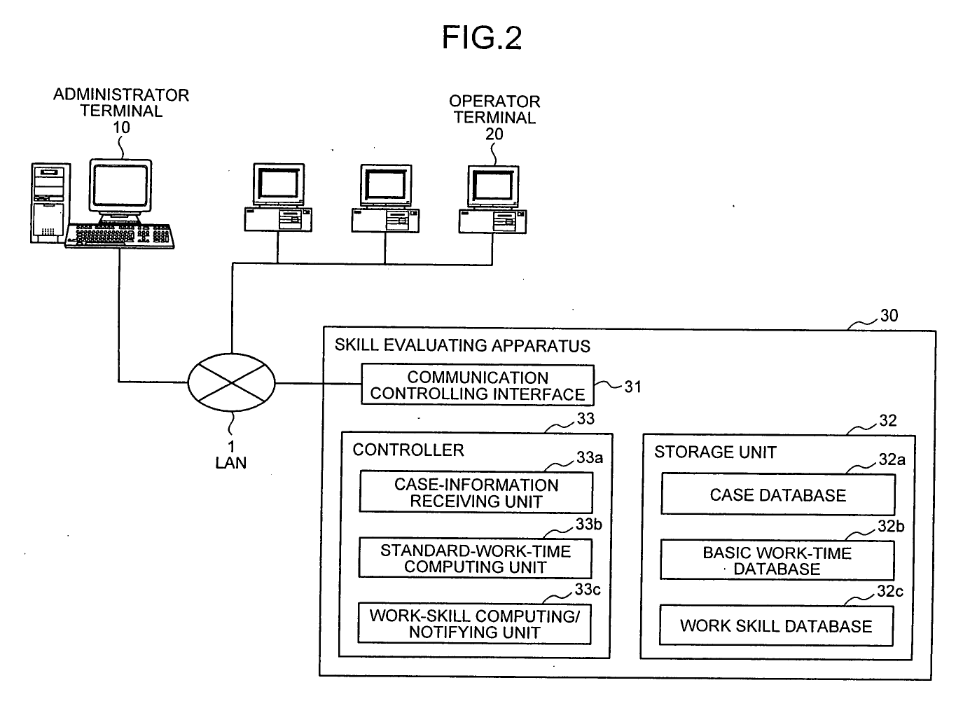

FIG. 2 is a block diagram of the skill evaluating apparatus 30. FIG. 3 is an example of an input screen.

The skill evaluating apparatus 30 is communicably connected to an administrator terminal 10 used by the administrator of the support center and an operator terminal 20 used by the operator engaged in customer support via a network such as a LAN 1. The skill evaluating apparatus 30 includes a communication controlling interface 31, a storage unit 32, and a controller 33. The communication controlling interface 31 controls communication with the administrator terminal 10 and the operator terminal 20.

The storage unit 32 stores therein data and programs required for processes performed by the controller 33. The storage unit 32 includes a case database 32a, a basic work-time database 32b, and a work skill database 32c.

FIG. 4 is an example of data stored in the case database 32a. The case database 32a stores therein case information including a work item and an actual work time received from the operator terminal 20. For example, the case database 32a stores information such as a case identification (ID), an operator ID, a customer ID, a model number, a starting time of work, a termination time of work, a trouble category, a trouble description, a work description, a trouble recovery flag, an actual work time, an inspection result of replaced part, a standard work time, and a case skill.

The case ID is an identifier unique to each case such as 2006060100025 to identify the case. The operator ID is an identifier unique to each operator such as CE00001 to identify the operator. The customer ID is an identifier such as CL12345 that uniquely identifies a customer. The model number is information of the model that the operator is fixing, such as MODEL300. The starting time of work is a date and time at which the operator starts the work, such as 2006/06/01 14:30. The termination time of work is a date and time at which the operator terminated the work, such as 2006/06/01 15:30. The trouble category is a category for classifying the trouble descriptions, which includes “not activated”, “power disabled”, or “memory error” according to the first embodiment. The trouble description is detail of the trouble. The work description is a specific work item of the maintenance work performed by the operator, which includes operating system (OS) reinstallation, driver repair, basic input/output system (BIOS) adjustment, central processing unit (CPU) replacement, mother board (MB) replacement, memory (MEM) replacement, and hard disk drive (HDD) replacement according to the first embodiment. The trouble recovery flag indicates whether the device is recovered from the trouble, and includes yes and no according to the first embodiment.

The actual work time is the time for which the operator actually performed the maintenance work such as 60 minutes, which is automatically calculated from the starting time of work and the termination time of work. The inspection result of replaced part indicates whether a part replaced during the maintenance work is defective, and it is input after an inspection of the replaced part performed after the maintenance work. Information of the inspection result of replaced part includes replacement of the CPU, MB, HDD, and MEM, and inspection result of defective or not defective. When there is a plurality of the inspection results of replaced part, the same number of the items as the inspection results is prepared. The standard work time is a work time such as 99.5 minutes typically required depending on the work item. The case skill is a skill value such as 1.66 to evaluate the skill of the operator, and calculated with respect to each case by comparing the standard work time and the actual work time.

FIG. 5 is an example of data stored in the basic work-time database 32b. The basic work-time database 32b stores therein the basic work time required for the operator to perform the work item with respect to each work item. For example, as shown in FIG. 5, the basic work-time database 32b associates the basic work time such as 15 minutes or 20 minutes with each work item with respect to each model number and each trouble category.

The model number and the trouble category correspond to the model number and the trouble category in the case database 32a respectively, and the work item corresponds to the information stored in the work item in the case database 32a. The basic work-time database 32b further includes investigation as a work item. This means a work of, for example, investigating the state of the trouble by opening a case of a faulty device. The basic work time in the basic work-time database 32b is acquired in advance from default information described in a maintenance manual or the like.

FIG. 6 is an example of data stored in the work skill database 32c. The work skill database 32c stores therein work skill value computed with respect to each operator when it receives an instruction to start processing from the administrator terminal. For example, as shown in FIG. 6, the work skill database 32c stores therein information of the operator ID, a location, the number of cases, and work skill.

The operator ID corresponds to the work ID stored in the case database 32a. The location indicates where the support center is located, such as Tokyo or Osaka, and stored in advance. The number of cases is the number of the maintenance works performed by each operator. The work skill indicates a skill value to evaluate the skill of each operator.

The controller 33 includes a memory to store therein a predetermined controlling program, other programs that define each processing procedure, and necessary data, and performs various processes based on the programs and data. The controller 33 includes a case-information receiving unit 33a, a standard-work-time computing unit 33b, and a work-skill computing/notifying unit 33c.

When the case-information receiving unit 33a receives a request to acquire an input screen from the operator terminal 20 of an operator that is going to process a new case, the case-information receiving unit 33a displays the input screen of the operator terminal 20, and stores the information input through the input screen (see FIG. 3) in the case database 32a.

In other words, upon receiving the request, the case-information receiving unit 33a displays the input screen of the operator terminal 20. If a new entry button is selected on the input screen, the case-information receiving unit 33a determines the case ID unique to the case. The ID is a 13-digit number including eight digits indicative of the year, the month, and the day, and five digits of a serial number. For example, an ID of the twenty-fifth case processed on June first, 2006 is “2006060100025” (see FIG. 3).

The case-information receiving unit 33a displays the case ID on the input screen of the operator terminal 20. The case-information receiving unit 33a then receives other items as input through the input screen such as the operator ID, the customer ID, the model number, the trouble category, the trouble description, the work description, the starting date and time of work, the termination date and time of work, and the trouble recovery, as shown in FIG. 3. If a completion of entry button is selected on the input screen of the operator terminal 20, the case-information receiving unit 33a stores information input through the input screen in the case database (see FIG. 4). The case-information receiving unit 33a writes the work time computed based on the starting time of work and the termination time of work in the case database 32a, and writes the inspection result of replaced part to be received later in the case database 32a.

Fixed information such as the operator ID, the customer ID, and the model number can be manually input by the operator or can be automatically input using an input supporting device or the like.

The standard-work-time computing unit 33b computes the standard work time when, for example, it receives an instruction to start processing from the administrator terminal 10.

The standard-work-time computing unit 33b selects any one of the case IDs, and reads data of the model number, the trouble category, and the work description that correspond to the selected case ID from the case database 32a. The standard-work-time computing unit 33b then extracts the basic work time corresponding to each of the work items included in the model number, the trouble category, and the work description from the basic work-time database 32b. If there is a plurality of the work items, a plurality of the basic work times are extracted. Based on the extracted basic work time, for example, by adding each of the extracted work times, the standard work time is computed. The standard-work-time computing unit 33b then writes the computed standard work time to the case database-32a. The above process is performed for all of the case data.

The work-skill computing/notifying unit 33c computes and presents the work skill value when, for example, it receives an instruction to start processing from the administrator terminal 10.

The work-skill computing/notifying unit 33c selects any operator ID, and acquires case IDs corresponding to the selected operator ID. The work-skill computing/notifying unit 33c selects one of the acquired case IDs, and reads the actual work time and the standard work time corresponding to the selected case ID from the case database 32a. The work-skill computing/notifying unit 33c computes the case skill value by dividing the standard work time by the actual work time, and writes the computed case skill value to the case database 32a. The work-skill computing/notifying unit 33c repeats the process to all of the cases operated by the operator. FIG. 7 is a chart of equations to calculate the case skill and work skill values. By computing the geometric mean of the computed case skill values using an equation (1) shown in FIG. 7, the work-skill computing/notifying unit 33c computes the work skill value of each operator. For example, if the computed case skill values are 0.8, 1.0, 1.2, and 1.5, the work skill is calculated using an equation (2) shown in FIG. 7. The work-skill computing/notifying unit 33c performs the process of writing the computed case skill value and the number of processed cases and the number of cases to the work skill database 32c for all the operators, and presents the work skill value on the administrator terminal 10 as requested by the administrator.

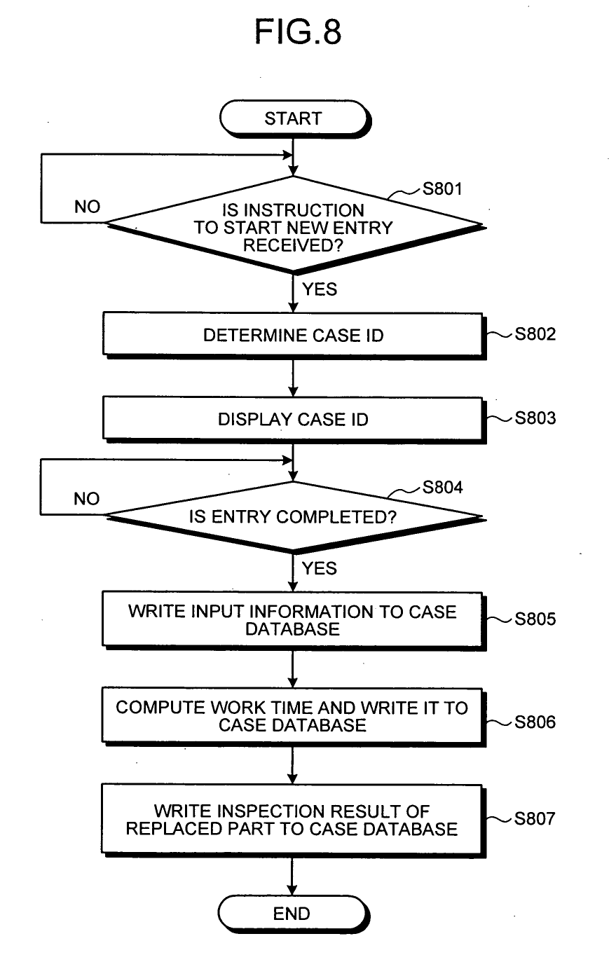

FIG. 8 is a flowchart of the operation of the case-information receiving unit 33a. When the case-information receiving unit 33a receives an instruction by selecting the new entry button on the input screen of the operator terminal 20 (YES at step S801), the case-information receiving unit 33a determines a case ID (step S802).

The case-information receiving unit 33a displays the determined case ID on the input screen (step S803). The case-information receiving unit 33a receives other items input through the input screen from the operator terminal 20 at any time, and determines whether the completion of entry button is selected on the input screen (step S804).

If the completion of entry button is selected (YES at step S804), the case-information receiving unit 33a stores information of each item input from the input screen in the case database 32a (step S805). If the completion of entry button is not selected (NO at step S804), the case-information receiving unit 33a waits for the completion of entry button to be selected.

The case-information receiving unit 33a computes the work time based on the starting time of work and the termination time of work and writes it to the case database 32a (step S806), and writes the inspection result of replaced part to be received later to the case database 32a (step S807) before terminating the process.

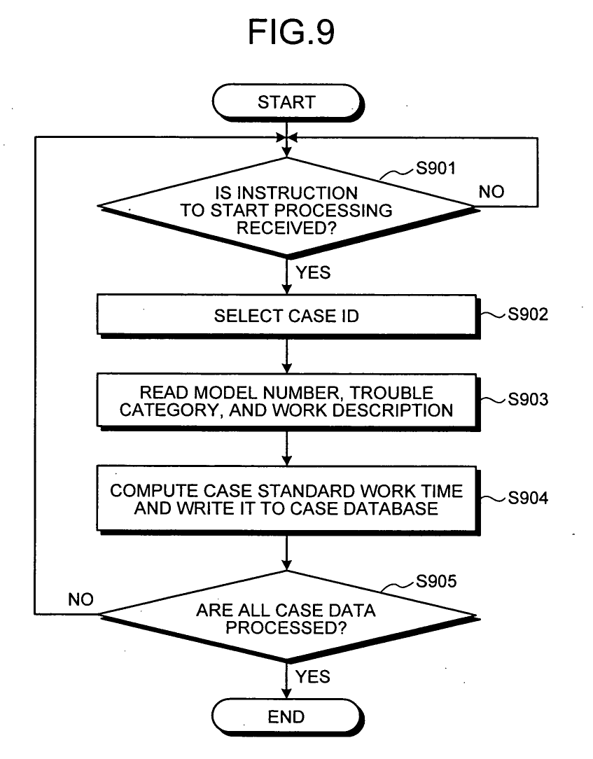

FIG. 9 is a flowchart of the operation of the standard-work-time computing unit 33b. When the standard-work-time computing unit 33b receives an instruction to start processing from the administrator terminal 10 (YES at step S901), it selects any one of the case IDs (step S902).

The standard-work-time computing unit 33b reads the data of the model number, the trouble category, and the work description corresponding to the selected case ID from the case database 32a (step S903). The standard-work-time computing unit 33b extracts the basic work time corresponding to each of the items read from the basic work-time database 32b. Based on the extracted basic work time, for example, by adding up the basic work times, the standard-work-time computing unit 33b computes the standard work time and writes the computed standard work time to the case database 32a (step S904).

The standard-work-time computing unit 33b determines whether all the case data have been processed (step S905). If all the case data have been processed (YES at step S905), the standard-work-time computing unit 33b terminates the process. If not all of the case data has been processed (NO at step S905), the standard-work-time computing unit 33b continues the process.

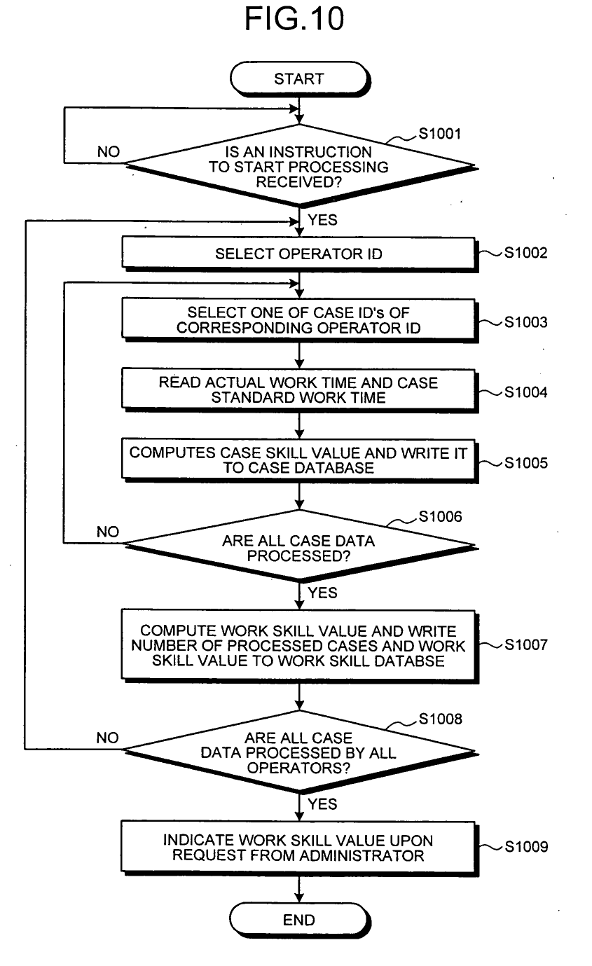

FIG. 10 is a flowchart of the operation of the work-skill computing/notifying unit 33c. When the work-skill computing/notifying unit 33c receives an instruction to start processing from the administrator terminal 10 (YES at step S1001), it selects any one of the operator IDs (step S1002).

The work-skill computing/notifying unit 33c acquires case IDs corresponding to the selected operator ID, and selects one of the acquired case IDs (step S1003). The work-skill computing/notifying unit 33c reads the actual work time and the standard work time corresponding to the selected case ID from the case database 32a (step S1004).

The work-skill computing/notifying unit 33c computes the case skill by dividing the standard work time by the actual work time, and writes the computed case skill value to the case database 32a (step S1005). The work-skill computing/notifying unit 33c determines whether all the case data of the selected operator has been processed (step S1006). If all the case data have been processed (YES at step S1006), the work-skill computing/notifying unit 33c computes the work skill value of each operator by computing the geometric average of the computed case skill values using an equation (1) shown in FIG. 7, and writes the number of cases processed by the operator and the computed work skill value to the work skill database 32c (step S1007). The work-skill computing/notifying unit 33c determines whether the process has been completed with respect to all the operators (step S1008). If the process has been completed by all the operators (YES at step S1008), the work-skill computing/notifying unit 33c presents the work skill value on the administrator terminal 10 upon request from the administrator (step S1009), and terminates the process.

If not all of the case data has been processed (NO at step S1006), the work-skill computing/notifying unit 33c continues the process of computing the case skill value by dividing the standard work time by the actual work time and writing it to the case database 32a. If the process has been completed by not all the operators (NO at step S1008), the work-skill computing/notifying unit 33c continues the process of computing the work skill value of each operator and writing the work skill value and the number of cases to the work skill database 32c.

While the standard work time is computed based on the basic work time extracted depending on the work item received from the operator according to the first embodiment, the propriety of the received work item can be determined before the standard work time is computed.

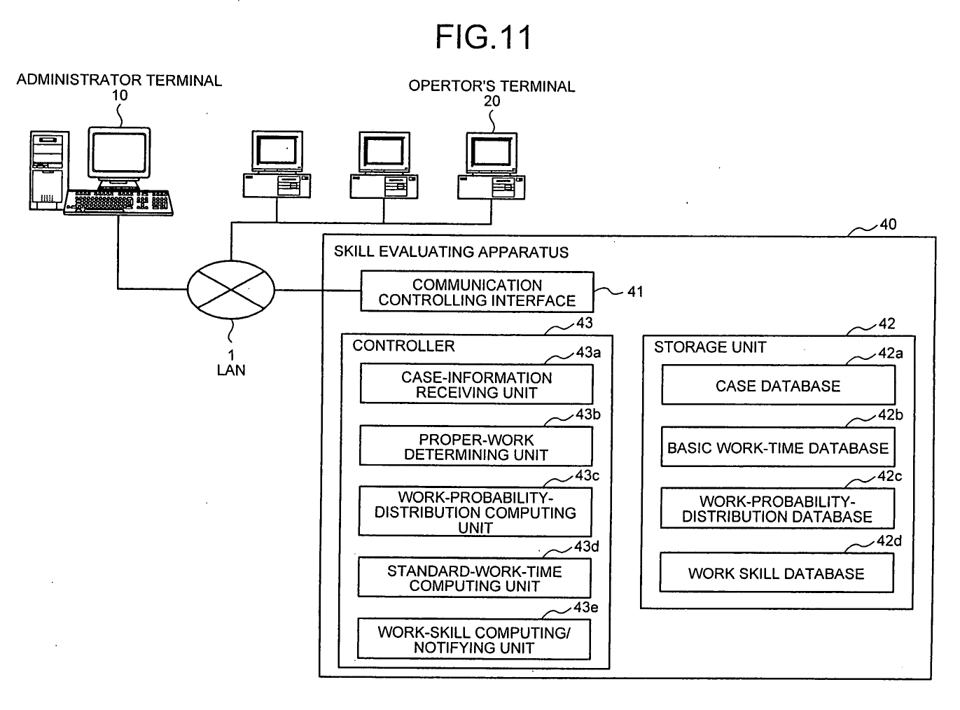

FIG. 11 is a block diagram of a skill evaluating apparatus 40 according to a second embodiment of the present invention.

The skill evaluating apparatus 40 is basically similar to the skill evaluating apparatus 30 explained in the first embodiment, and different features are explained below.

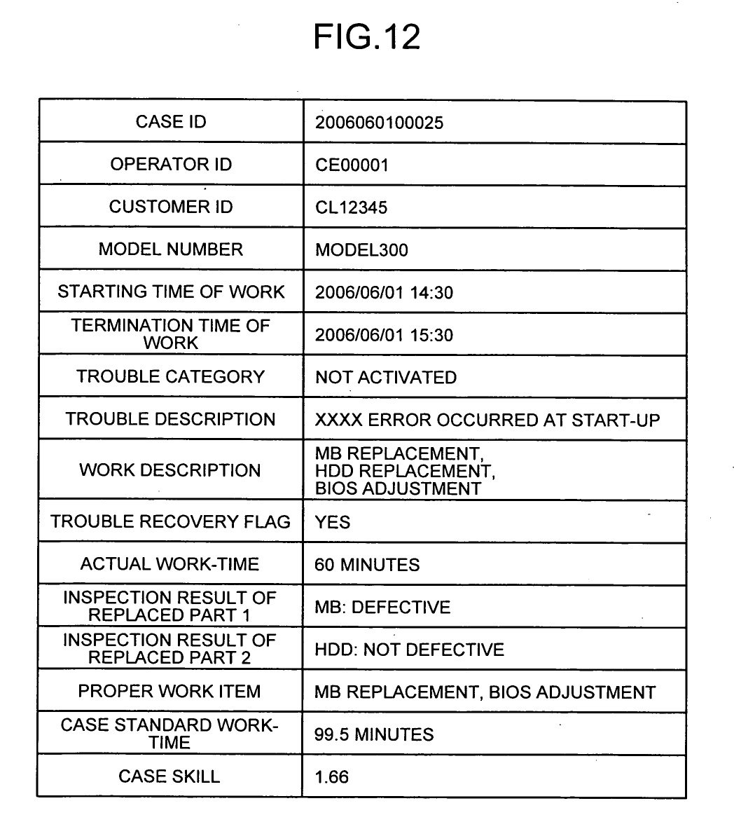

FIG. 12 is an example of data stored in a case database 42a. The case database 42a in a storage unit 42 stores therein a proper work item as shown in FIG. 12 as well as the case ID, the operator ID, the customer ID, the model number, the starting time of work, the termination time of work, the trouble category, the trouble description, the work description, the trouble recovery flag, the actual work time, the inspection result of replaced part, the standard work time, and the case skill explained in the first embodiment.

The proper work item is a work item written in the work description such as the MB replacement or the BIOS adjustment. It is the work item having been effective in processing the case such as recovery from a trouble and being determined to be proper by a proper-work determining unit 43b to be described later.

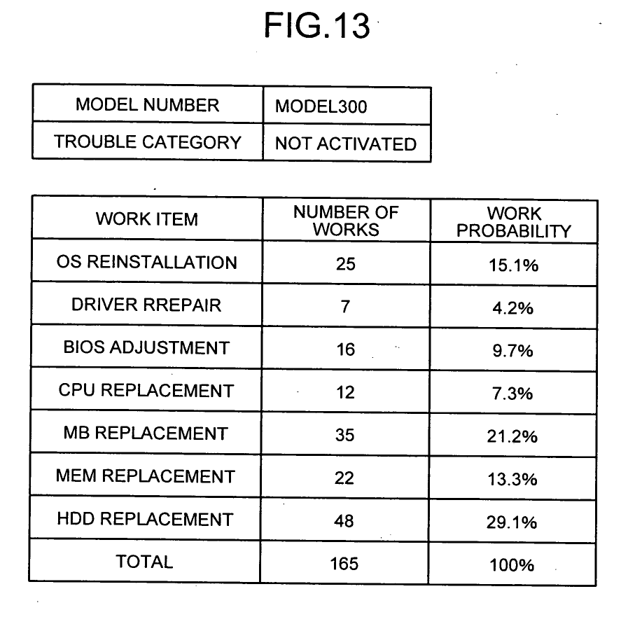

FIG. 13 is an example of data stored in a work-probability-distribution database 42c according to the second embodiment. The work-probability-distribution database 42c in the storage unit 42 stores therein work probability with respect to each model number and each trouble category. For example, as shown in FIG. 13, the work-probability-distribution database 42c stores therein the number of works and work probability in association with the work item with respect to each model number and each trouble category.

Information in the model number, the trouble category, and the work item correspond to the work items stored in the model number, the trouble category, and the work item in the case database 42a, respectively. The number of works is the number of pieces of case information counted with respect to each work item. The work probability is the probability of the work item being performed in the work process. The number of works and the work probability are written by a work-probability-distribution computing unit 43c to be described later.

The proper-work determining unit 43b in a controller 43 determines the propriety of the work item when, for example, it receives an instruction to start processing from the administrator terminal 10.

More specifically, the proper-work determining unit 43b selects any case ID, reads data of the trouble recovery flag corresponding to the selected case ID from the case database 42a, and determines whether the trouble in the case is fixed. If the trouble is fixed (for example, if the trouble recovery flag indicates yes), the proper-work determining unit 43b reads one of the work items in the case database 42a, and determines whether the work item is a part replacement. If it is the part replacement, the proper-work determining unit 43b reads the data in the inspection result of replaced part from the case database 42a, and determines whether the data indicates the replaced part is defective or not defective. If the replaced part is defective, the proper-work determining unit 43b determines that the work item, namely the part replacement, was proper, and writes the proper work item to the proper work item in the case database 42a.

If the work item is not the part replacement (for example, if the work item is the OS reinstallation, the driver repair; or the BIOS adjustment), the proper-work determining unit 43b determines whether the work item is the last in the work process. If it is the last work item, the proper-work determining unit 43b determines that the work item was proper, and writes the proper work item to the case database 42a.

If the inspection result of the replaced part is not defective, or if the proper work item has been written to the case database 42a, the proper-work determining unit 43b determines whether the propriety of all the work items in the case database 42a has been determined. If the propriety of all the work items has been determined, the proper-work determining unit 43b determines whether all the case data have been processed. If not all of the work items have been processed, the proper-work determining unit 43b reads another work item and continues the process.

If all the case data have been processed, the proper-work determining unit 43b terminates the process. If not all of the case data has been processed, the proper-work determining unit 43b selects an unprocessed case ID and continues the process.

The work-probability-distribution computing unit 43c computes work probability distribution indicative of distribution of probabilities that the work item can be performed in the work process when, for example, it receives an instruction to start processing from the administrator terminal 10.

More specifically, the work-probability-distribution computing unit 43c selects any one of the trouble categories and any one of the model numbers in the case database 42a.

The work-probability-distribution computing unit 43c reads the case information corresponding to the selected trouble category and the selected model number from the case database 42a, and counts the number of pieces of the case information that includes a corresponding work item with respect to each work item in the work description. The work-probability-distribution computing unit 43c then computes the work probability by dividing the number of the works counted with respect to each work item by the number of processed cases in all the work items.

For example, the number of works associated with the OS reinstallation is 25 in FIG. 13. This means that the number of works counted for the work item “OS reinstallation” is 25 among the cases of which the model number is “MODEL300” and the trouble category is “not activated”. The number of works associated with the “total” is 165. This means that the number of works in all the work items is 165 as a result of totaling the numbers counted for all the work items in the cases of which the model number is “MODEL300” and the trouble category is “not activated”. As a result of dividing 25 by 165, the work probability of the OS reinstallation is 15.1%.

The work-probability-distribution computing unit 43c writes the computed work probability to the work-probability-distribution database 42c. The work-probability-distribution computing unit 43c performs the same process for all the model numbers and all the trouble categories.

A standard-work-time computing unit 43d in the controller 43 computes an expected value of the standard work time based on the standard work time extracted from the basic work-time database 32b and the work probability distribution when, for example, it receives an instruction to start processing from the administrator terminal 10.

More specifically, the standard-work-time computing unit 43d selects any case ID, reads the model number and the trouble category corresponding to the selected case ID from the case database 42a, and determines whether any proper work item is written. If the proper work item is written, the standard-work-time computing unit 43d reads one of the proper work items, and computes the standard work time of the proper work item.

The standard-work-time computing unit 43d reads work probability data corresponding to the model number and the trouble category from the work-probability-distribution database 42c, and reads basic work-time data from a basic work-time database 42b. The standard-work-time computing unit 43d creates a work process in which the work item read as a proper work item is performed last.

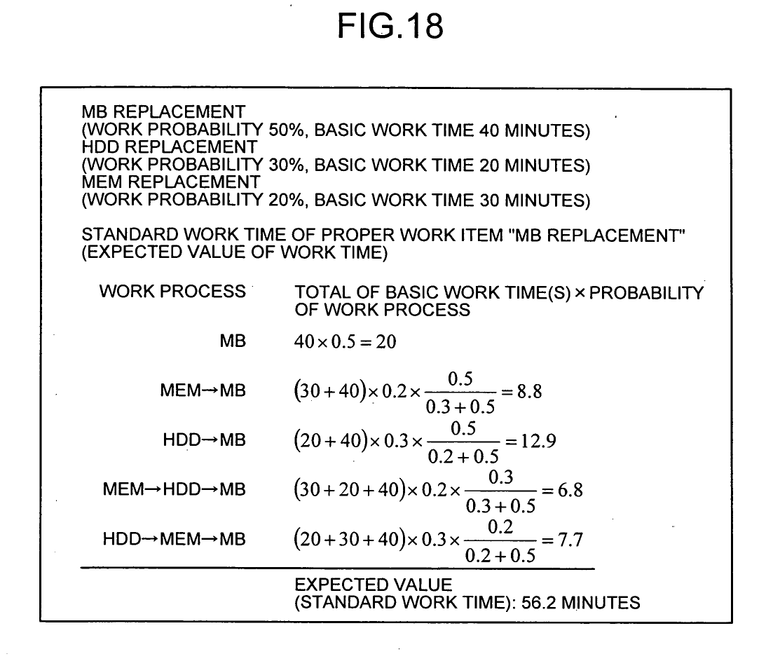

In other words, the standard-work-time computing unit 43d rearranges work items of which the work probability is higher than 0% in the work probability data read from the work-probability-distribution database 42c, and creates all possible work processes. For example, as shown in FIG. 18, when the proper work item is the MB replacement and the work items of which the work probability is higher than 0% are the MB replacement, the HDD replacement, and the MEM replacement, there are five patterns of the work process in which the MB replacement is performed last, including “MB replacement”, “MEM replacement, MB replacement”, “HDD replacement, MB replacement”, “MEM replacement, HDD replacement, MB replacement”, and “HDD replacement, MEM replacement, MB replacement”. When the work process is created, there is no restriction except that the work item read as the proper work item should be performed last. There is no need to use all of the work items of which the work probability is higher than 0%.

After the work process is created, the standard-work-time computing unit 43d computes the expected value of the standard work time for the proper work item. Specifically, the standard-work-time computing unit 43d extracts the basic work time corresponding to each work item in each of the created work processes from the basic work-time data, computes a total of the basic work times in each work process, and multiplies the total of the basic work times by the work probabilities of the work items to compute the expected value of the standard work time. For example, as shown in FIG. 18, the expected value of “MB replacement” is 20 minutes, the expected value of “MEM replacement, MB replacement” is 8.8 minutes, the expected value of “HDD replacement, MB replacement” is 12.9 minutes, the expected value of “MEM replacement, HDD replacement, MB replacement” is 6.8 minutes, the expected value of “HDD replacement, MEM replacement, MB replacement” is 7.7 minutes, and the expected value of the standard work time of the MB replacement is 56.2 minutes. Then, 56.2 minutes is used as the standard work time of the proper work item read from the case database 42a.

The standard-work-time computing unit 43d determines whether the standard work time has been computed for all the proper work items in the case database 42a. If the standard work time has been computed for all of them, the standard-work-time computing unit 43d adds an investigation time read from the basic work-time database 42b to the computed expected value (or the total of the expected values) to compute the standard work time for processing the case, and writes it to the case database 42a as a standard work time.

To cite an example of computing the standard work time, if the proper work items are the MB replacement and the BIOS adjustment, the investigation time is 15 minutes, the expected value of the standard work time for the MB replacement is 56.2 minutes, and that for the BIOS adjustment is 28.3 minutes, the standard work time is 99.5 minutes, which is the total of the values. If there is no proper work item and there is no expected value of the standard work time, 15 minutes equal to the investigation time is the standard work time.

If all the cases have been processed, the standard-work-time computing unit 43d terminates the process. If not all of the cases have been processed, the standard-work-time computing unit 43d selects an unprocessed case ID and continues the process.

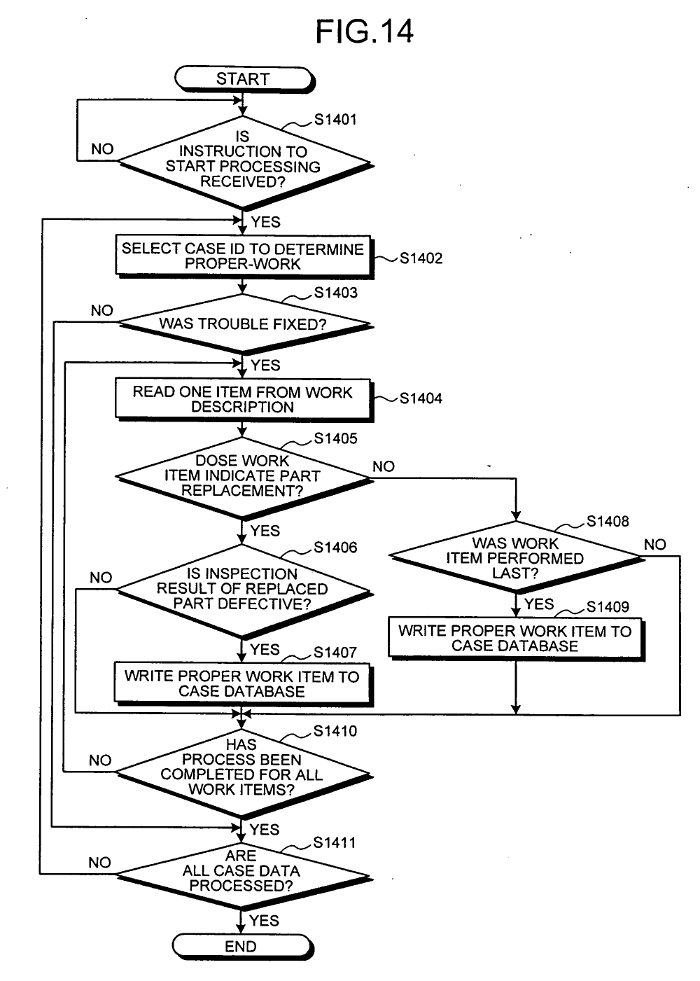

FIG. 14 is a flowchart of the operation of the proper-work determining unit 43b. When the proper-work determining unit 43b receives an instruction to start processing from the administrator terminal 10 (YES at step S1401), it selects any case ID to be processed (step S1402).

The proper-work determining unit 43b reads data of the trouble recovery flag corresponding to the selected case ID from the case database 42a, and determines whether the trouble in the case has been fixed (step S1403). If the trouble has been fixed (YES at step S1403), the proper-work determining unit 43b reads one of the work items from the work description in the case database 42a (step S1404), and determines whether the work item indicates a part replacement (step S1405).

If the work item indicates the part replacement (YES at step S1405), the proper-work determining unit 43b reads data as to the inspection result of replaced part from the case database 42a, and determines whether the result is defective or not defective (step S1406). If the result is defective (YES at step S1406), the work item was proper, and the proper-work determining unit 43b writes the proper work item to the case database 42a (step S1407).

If the work item is not the part replacement (NO at step S1405), the proper-work determining unit 43b determines whether the work item was performed last of the work process (step S1408). If the work item was performed last (YES at step S1408), the work item was proper, and the proper-work determining unit 43b writes the proper work item to the case database 42a (step S1409).

If the result of the step S1406 is not defective (NO at step S1406), if the work item was not performed last (NO at step S1408), or if the proper work item has been written to the case database 42a (steps S1407 and S1409), the proper-work determining unit 43b determines whether the propriety of all the work items in the work description has been determined (step S1410). If the propriety of all the work items in the work description has been determined (YES at step S1410), the proper-work determining unit 43b determines whether all the case data have been processed (step S1411). If all the case data have been processed (YES at step S1411), the proper-work determining unit 43b terminates the process.

If the propriety of not all the work items in the work description has been determined (NO at step S1410), the proper-work determining unit 43b selects' another work item from the work description in the case database 42a and continues the process (steps S1404 to S1409). If not all the case data have been processed (NO at step S1411), the proper-work determining unit 43b selects another unprocessed case ID and continues the process (step S1402 to S1409).

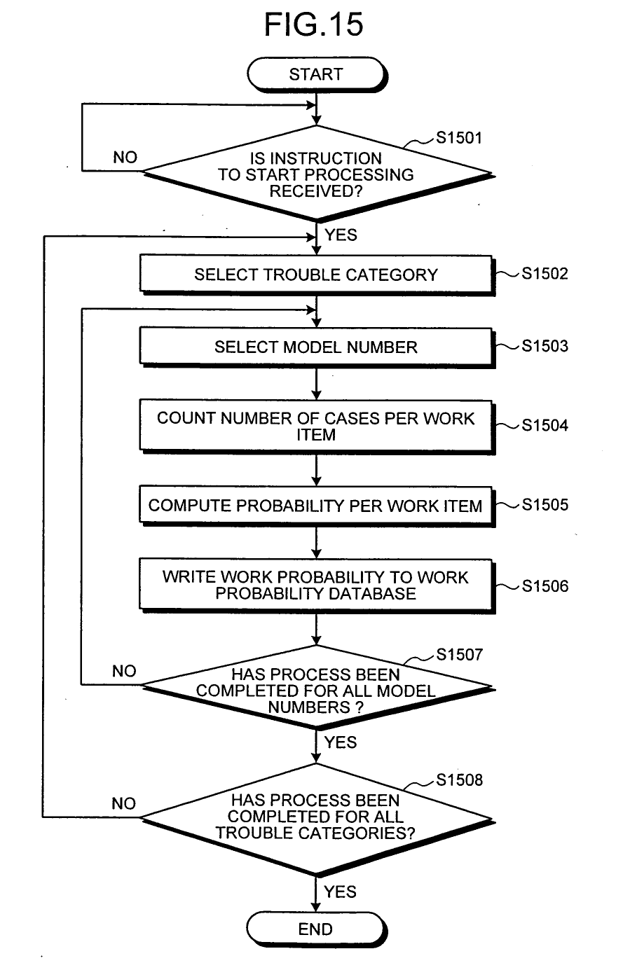

FIG. 15 is a flowchart of the operation of the work-probability-distribution computing unit 43c. When the work-probability-distribution computing unit 43c receives an instruction to start processing from the administrator terminal 10 (YES at step S1501), it selects any one of the trouble categories from the case database 42a (step S1502), and selects one of the model numbers from the case database 42a (step S1503).

The work-probability-distribution computing unit 43c reads the case information corresponding to the selected trouble category and the selected-model number from the case database 42a and counts the number of pieces of the case information that includes a corresponding work item with respect to each work item in the work description (step S1504). The work-probability-distribution computing unit 43c computes the work probability by dividing the number of the works counted with respect to each work item by the number of processed cases in all the work items (step S1505).

The work-probability-distribution computing unit 43c writes the computed work probability to the work-probability-distribution database 42c (step S1506), and determines whether the process has been performed for all the model numbers (step S1507). If the process has been performed for all the model numbers (YES at step S1507), the work-probability-distribution computing unit 43c determines whether the process has been performed for all the trouble categories (step S1508). If the process has been performed for all the trouble categories (YES at step S1508), the work-probability-distribution computing unit 43c terminates the process. If the process has been performed for not all the model numbers (NO at step S1507), or if the process has been performed for not all the trouble categories (NO at step S1508), the work-probability-distribution computing unit 43c continues the process until all of them are processed.

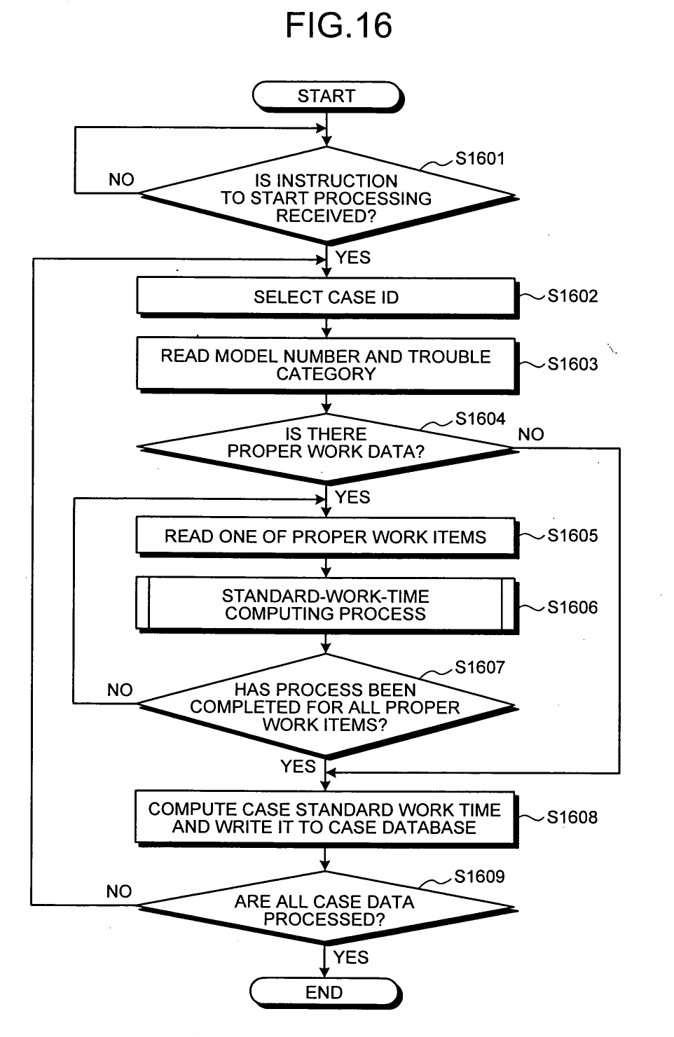

FIG. 16 is a flowchart of the operation of the standard-work-time computing unit 43d. When the standard-work-time computing unit 43d receives an instruction to start processing from the administrator terminal 10 (step S1601), it selects any case ID (step S1602).

The standard-work-time computing unit 43d reads the model number and the trouble category corresponding to the selected case ID from the case database 42a (step S1603), and determines whether any proper work item is written (step S1604). If the proper work item is written (YES at step S1604), the standard-work-time computing unit 43d reads one of the proper work items (step S1605), and computes the standard work time of the proper work item (step S1606).

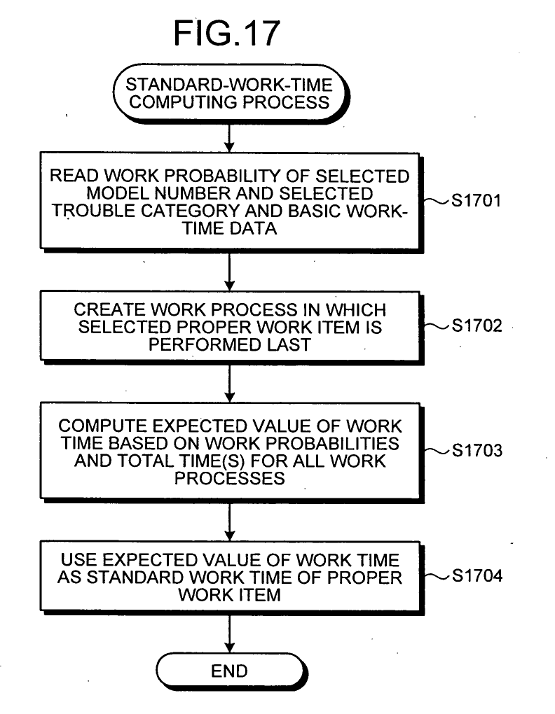

FIG. 17 is a detailed flowchart of the standard-work-time computing process at step S1606. Specifically, the standard-work-time computing unit 43d reads the work probability data corresponding to the model number and the trouble category from the work-probability-distribution database 42c, and reads the basic work-time data from the basic work-time database 42b (step S1701).

The standard-work-time computing unit 43d creates a work process (procedure) in which the work item read as a proper work item is performed last (step S1702).

After the work process is created, the standard-work-time computing unit 43d computes the expected value of the work time for the proper work item (step S1703).

The standard-work-time computing unit 43d uses the expected value as the standard work time of the proper work item read from the case database 42a (step S1704).

Returning to the explanation of FIG. 16, after the standard work time of the proper work item is computed (step S1606) the standard-work-time computing unit 43d determines whether the standard work time has been computed for all the proper work items in the case database 42a (step S1607). If the standard work time has been computed for all of them (YES at step S1607), the standard-work-time computing unit 43d computes the standard work time for processing the case, and writes it to the case database 42a (step S1608).

If the standard work time has been computed for not all of them (NO at step S1607), the standard-work-time computing unit 43d selects another proper work item from the case database 42a, and continues the process (steps S1605 and S1606).

If the proper work item is not written (NO at step S1604), the standard-work-time computing unit 43d also computes the standard work time and writes it to the case database 42a (step S1608). In this case, the investigation time read from the basic work-time database 42b is written as the standard work time.

After the standard work time is computed and written to the case database 42a, the standard-work-time computing unit 43d determines whether all the cases have been processed (step S1609). If all the cases have been processed (YES at step S1609), the standard-work-time computing unit 43d terminates the process. If not all of the cases have been processed (NO at step S1609), the standard-work-time computing unit 43d selects another unprocessed case ID and continues the process (steps S1602 to S1608).

While the exemplary embodiments are described above, the present invention can be carried out in different modes.

Units included in the skill evaluating apparatus 30 shown in FIG. 2 and the skill evaluating apparatus 40 shown in FIG. 11 represent conceptual functions, and they do not need to be physically configured as shown in the drawings. A part or all of the units can be functionally or physically combined or split in any size depending on various loads-on the units or the condition of use. For example, the standard-work-time computing unit 33b and the work-skill computing/notifying unit 33c can be combined, or the proper-work determining unit 43b, the work-probability-distribution computing unit 43c, and the standard-work-time computing unit 43d can be combined. Moreover, a part or all of the processing functions executed in the skill evaluating apparatus 30 and the skill evaluating apparatus 40 (see FIGS. 8 to 10 and FIGS. 15 to 17) can be realized as a CPU, a computer program executed by the CPU, or hardware using wired logic.

The processing procedures, the controlling procedures, the specific names, and the information including various data and parameters described above can be freely changed except specified otherwise.

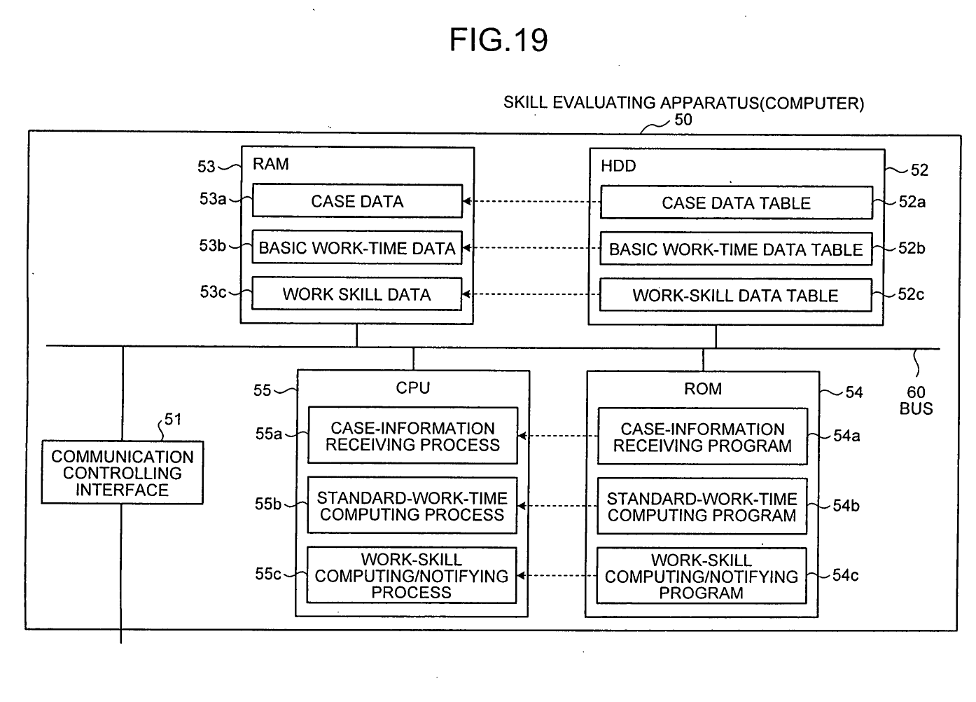

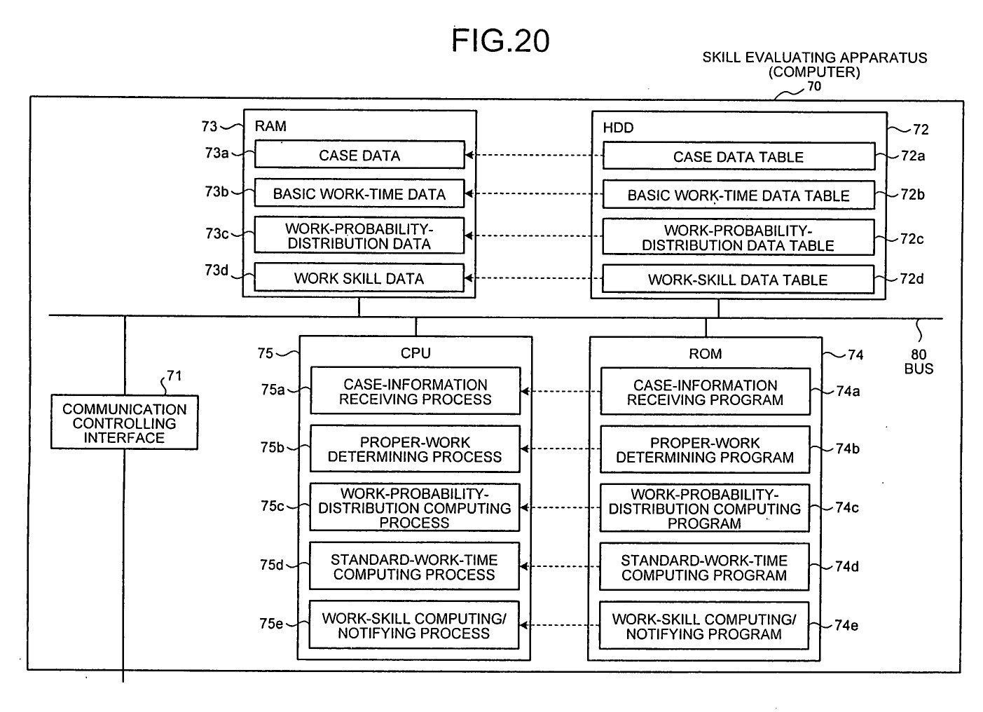

Various processes performed by the skill evaluating apparatus 30 and the skill evaluating apparatus 40 can be realized by executing a computer program (hereinafter, “skill evaluating program”) prepared in advance in a computer system such as a personal computer or a workstation. FIG. 19 is a schematic of a computer that executes a skill evaluating program, and FIG. 20 is a schematic of another computer that executes the skill evaluating program.

As shown in FIG. 19, a computer 50 that operates as a skill evaluating apparatus includes a communication controlling interface 51, an HDD 52, a random access memory (RAM) 53, a read only memory (ROM) 54, and a CPU 55 connected with a bus 60. The communication controlling interface 51 corresponds to the communication controlling interface 31 shown in FIG. 2.

The ROM 54 stores therein a skill evaluating program that operates as the skill evaluating apparatus 30, i.e., a case-information receiving program 54a, a standard-work-time computing program 54b, and a work-skill computing/notifying program 54c, in advance. The programs 54a, 54b, and 54c can be combined or split as needed, and the ROM 54 can be a nonvolatile RAM.

By the CPU 55 reading the programs 54a, 54b, and 54c from the ROM 54 and executing them, the programs 54a, 54b, and 54c function as a case-information receiving process 55a, a standard-work-time computing process 55b, and a work-skill computing/notifying process 55c, respectively. The processes 55a, 55b, and 55c correspond to the case-information receiving unit 33a, the standard-work-time computing unit 33b, and the work-skill computing/notifying unit 33c, respectively.

The HDD 52 includes a case data table 52a, a basic work-time data table 52b, and a work-skill data table 52c. The case data table 52a, the basic work-time data table 52b, and the work-skill data table 52c correspond to the case database 32a, the basic work-time database 32b, and the work skill database 32c, respectively. The CPU 55 reads case data 53a, basic work-time data 53b, and work skill data 53c from the case data table 52a, the basic work-time data table 52b, and the work-skill data table 52c, respectively, and stores them in the RAM 53. The CPU 55 performs the skill evaluating process based on the case data 53a, the basic work-time data 53b, and the work skill data 53c in the RAM 53.

The programs 54a, 54b, and 54c do not need to be stored in the ROM 54 in advance. The programs can be stored in a removable physical medium such as a flexible disk (FD), a compact disc read only memory (CD-ROM), a digital versatile disk (DVD), a magneto optical disk, or an integrated circuit card to be inserted into the computer 50, a fixed physical medium such as an HDD disposed inside or outside of the computer 50, or another computer or server connected to the computer 50 via a public line, the internet, a LAN, or a wide area network (WAN), and the computer 50 can read and execute the programs.

As shown in FIG. 20, a computer 70 that operates as a skill evaluating apparatus includes a communication controlling interface 71, an HDD 72, a RAM 73, a ROM 74, and a CPU 75 connected with a bus 80. The communication controlling interface 71 corresponds to a communication controlling interface 41 shown in FIG. 11.

The ROM 74 stores therein a skill evaluating program that operates as the skill evaluating apparatus 40, i.e., a case-information receiving program 74a, a proper-work determining program 74b, a work-probability-distribution computing program 74c, a standard-work-time computing program 74d, and a work-skill computing/notifying program 74e, in advance. The programs 74a to 74e can be combined or split as needed, and the ROM 74 can be a nonvolatile RAM.

By the CPU 75 reading the programs 74a to 74e from the ROM 74 and executing them, the programs 74a to 74e function as a case-information receiving process 75a, a proper-work determining process 75b, a work-probability-distribution computing process 75c, a standard-work-time computing process 75d, and a work-skill computing/notifying process 75e, respectively. The processes 75a to 75e correspond to a case-information receiving unit 43a, the proper-work determining unit 43b, the work-probability-distribution computing unit 43c, the standard-work-time computing unit 43d, and a work-skill computing/notifying unit 43e, respectively.

The HDD 72 includes a case data table 72a, a basic work-time data table 72b, a work-probability-distribution data table 72c, and a work-skill data table 72d. The case data table 72a, the basic work-time data table 72b, the work-probability-distribution data table 72c, and the work-skill data table 72d correspond to the case database 42a, the basic work-time database 42b, the work-probability-distribution database 42c, and a work skill database 42d, respectively. The CPU 75 reads case data 73a, basic work-time data 73b, work-probability-distribution data 73c, and work skill data 73d from the case data table 72a, the basic work-time data table 72b, the work-probability-distribution-data table 72c, and the work-skill data table 72d, respectively, and stores them in the RAM 73. The CPU 75 performs the skill evaluating process based on the case data 73a, the basic work-time data 73b, the work-probability-distribution data 73c, and the work skill data 73d in the RAM 73.

The programs 74a to 74e do not need to be stored in the ROM 74 in advance. The programs can be stored in a removable physical medium such as an FD, a CD-ROM, a DVD, a magneto optical disk, or an integrated circuit card to be inserted into the computer 70, a fixed physical medium such as an HDD disposed inside or outside of the computer 70, or another computer or server to be connected to the computer 70 via a public line, the internet, a LAN, or a WAN, and the computer 70 can read and execute the programs.

As set forth hereinabove, according to an embodiment of the present invention, the basic work time is retained as a default with respect to each work item. At least the work item and the actual work time are received from an operator as the case information. The basic work time corresponding to the received work item is extracted from the retained basic work times. Based on the extracted basic work time, the standard work time is computed, and the received actual work time is compared with the computed standard work time. As a result, the skill of the operator can be evaluated while taking into account the work item that the operator can perform as the work process to process a case.

Moreover, the propriety of the work item received as the case information is determined, and the basic work time is extracted from the retained basic work time taking into account the determined propriety of the work item. The standard work time is computed based on the basic work time, and is compared with the actual work time received as the case information to evaluate skill of an operator. As a result, the skill of the operator is evaluated taking into account the propriety of the work item in addition to the work item itself.

Furthermore, the work probability distribution is computed for the work item received as the case information, and the expected value of the time required to process the case is computed as the standard work time based on the extracted basic work time and the computed work probability distribution. The standard work time is computed taking into account trial and error by the operator to select the work item by using the work probability distribution. As a result, the skill of the operator is evaluated taking into account the uniqueness of the work process because, in comparing the actual work time with the standard work time, for example, the actual work time is shorter when the work process is unique.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program that causes a computer to execute:
storing in advance a basic work time required for an operator to perform a work item in a work process for processing a case;
receiving information on at least a work item and an actual work time taken to process a case from the operator;
extracting a basic work time that corresponds to the work item informed by the operator;
computing a standard work time generally required to process the case based on extracted basic work time; and
evaluating skill of the operator by comparing the actual work time with the standard work time.

2. The computer-readable recording medium according to claim 1, further causing the computer to execute determining propriety of the work item, wherein
the extracting includes extracting the basic work time with consideration of the propriety of the work item.

3. The computer-readable recording medium according to claim 2, further causing the computer to execute computing a work probability distribution of the work item, the work probability distribution being probability that the work item is to be performed in the work process, wherein
the computing the standard work time includes computing an expected value of time required to process the case based on the basic work time extracted with consideration of the propriety of the work item and the work probability distribution, the expected value being used as the standard work time.

4. A skill evaluating method for evaluating skill of an operator comprising:
storing in advance a basic work time required for the operator to perform a work item in a work process for processing a case;
receiving information on at least a work item and an actual work time taken to process a case from the operator;
extracting a basic work time that corresponds to the work item informed by the operator;
computing a standard work time generally required to process the case based on extracted basic work time; and
evaluating skill of the operator by comparing the actual work time with the standard work time.

5. The skill evaluating method according to claim 4 further comprising determining propriety of the work item, wherein
the extracting includes extracting the basic work time with consideration of the propriety of the work item.

6. The skill evaluating method according to claim 5 further comprising computing a work probability distribution of the work item, the work probability distribution being probability that the work item is to be performed in the work process, wherein
the computing the standard work time includes computing an expected value of time required to process the case based on the basic work time extracted with consideration of the propriety of the work item and the work probability distribution, the expected value being used as the standard work time.

7. A skill evaluating apparatus that evaluates skill of an operator, the skill evaluating apparatus comprising:
a storing unit that stores therein in advance a basic work time required for the operator to perform a work item in a work process for processing a case;
an information receiving unit that receives information on at least a work item and an actual work time taken to process a case from the operator;
a basic-work-time extracting unit that extracts, from the storing unit, a basic work time that corresponds to the work item informed by the operator;
a standard-work-time computing unit that computes a standard work time generally required to process the case based on extracted basic work time; and
an evaluating unit that evaluates skill of the operator by comparing the actual work time with the standard work time.

8. The skill evaluating apparatus according to claim 7 further comprising a propriety determining unit that determines propriety of the work item, wherein
the basic-work-rime extracting unit extracts the basic work time with consideration of the propriety of the work item.

9. The skill evaluating apparatus according to claim 8 further comprising a work-probability-distribution computing unit that computes a work probability distribution of the work item, the work probability distribution being probability that the work item is to be performed in the work process, wherein
the standard-work-time computing unit computes an expected value of time required to process the case based on the basic work time extracted with consideration of the propriety of the work item and the work probability distribution, the expected value being used as the standard work time.
